(19) United States
(12) Patent Application Publication
(10) Pub. No.: US 2023/0135058 A1
(43) Pub. Date: May 4, 2023

(54) SYSTEM AND METHOD FOR USER INTERFACE MANAGEMENT FOR ASYMMETRIC CAPACITY AND TIME UNIT ALLOCATION

(71) Applicant: Seth Feuerstein, New Haven, CT (US)

(72) Inventor: Seth Feuerstein, New Haven, CT (US)

(21) Appl. No.: 17/977,309

(22) Filed: Oct. 31, 2022

Related U.S. Application Data
(60) Provisional application No. 63/273,497, filed on Oct. 29, 2021.

(51) Int. Cl. G06Q 10/10; G06Q 30/02

(52) U.S. Cl. CPC G06Q 10/1095; G06Q 30/0236

(57) ABSTRACT

The present invention provides a computerized system and method for controlling a user interface to provide for asymmetrical, preferential scheduling of appointments on an incentivized basis. The system may be used, for example, by health plan operators to incentivize healthcare/medical providers to provide treatment to patients that are members of the health plan, to ensure treatment is rendered in better alignment with each individual patient's or plans' needs. Further, the system may be used by health plan operators to incentivize healthcare/medical providers to promote rendering of care in a manner providing better patient outcomes, or otherwise better meeting objectives of the health plan operator. Further still, the system may be used to provide financial or other reward to providers for better of faster care to patients. Other advantages including providing improved patient access to needed healthcare/medical resources, and the ability to align incentives with dynamic payment tools.

### CROSS-REFERENCE TO RELATED APPLICATION

This application claims the benefit of priority of U.S. Provisional Patent Application No. 63/273,497, filed Oct. 29, 2021, the entire disclosure of which is hereby incorporated herein by reference.

### FIELD OF THE INVENTION

The present invention relates to controlling a user interface of a computerized system to providing for asymmetrical, preferential allocation of limited or variable value clinical expertise.

### DISCUSSION OF RELATED ART

There are many instances and contexts in which the level of expertise required, time sensitive nature of the need or value of the need varies, and/or demand exceeds available resources, and an allocation of limited resources must be made. Visibility into these needs and the value and shortages has been a consistent and growing problem, particularly in some cases, such as healthcare, in which the value and need is not knowable to those who have the required level of expertise. One such example involves scheduling of appointments for the right level or speed-of-delivery of services. For example, physicians, healthcare providers, medical testing labs and others in the medical/healthcare industry typically provide services to patients/persons according to scheduled appointments. Frequently, the demand for appointments exceeds the availability of appointments, at least on a short-term basis (e.g., over a matter of days, weeks, or months).

Often, resources in the nature of available appointments (days/times) are allocated on a non-differentiated, “symmetric” basis, without particular regard to prioritization or preferential scheduling for any appointments. For example, appointments with a dentist/hygienist for a routine dental cleaning/prophylaxis may be allocated to a requested patient on a next-available basis, in the order in which requests are made by patients. Sometimes, types of appointments may be prioritized. For example, an urgent need of one patient for a root canal or tooth repair due to extreme pain may be prioritized over a request for a routine dental cleaning by another patient. However, often, different patients requesting root canal/tooth repair may be scheduled symmetrically, such that all patients are provided with similar prioritization over more routine/less urgent types of appointments, but generally no prioritization is provided among all patients requiring the same service.

In some instances, it may be advantageous or desirable to provide for prioritization of appointment resource allocation among patients requiring the same service.

What is needed is a system and method providing a system and method for controlling a user interface to provide for asymmetrical, preferential scheduling of appointments on an incentivized basis.

### SUMMARY

The present invention provides a computerized system and method for controlling a user interface to provide for asymmetrical, preferential scheduling of appointments (allocation of limited appointment availability resources) on an incentivized basis. The system may be used, for example, by health plan operators to incentivize healthcare/medical providers to provide treatment to patients that are members of a particular health plan, to ensure treatment is rendered in better alignment with each individual patient's or plan's needs. Further, the system may be used by health plan operators to incentivize healthcare/medical providers to promote rendering of care in a manner providing better patient outcomes, or otherwise better meeting objectives of the health plan operator. Further still, the system may be used to provide financial or other reward to providers for better of faster care to patients. Other advantages including providing improved patient access to needed healthcare/medical resources, and the ability to align incentives with dynamic payment tools.

### BRIEF DESCRIPTION OF THE FIGURES

For a better understanding of the present invention, reference may be made to the accompanying drawings in which:

FIG. 1 is a system diagram showing an exemplary network computing environment in which the present invention may be employed;

FIG. 2 is a schematic diagram of an exemplary special-purpose Asymmetry-Based Scheduling System computing device in accordance with an exemplary embodiment of the present invention;

FIG. 3 is a flow diagram illustrating exemplary operation of the Asymmetry-Based Scheduling System of FIG. 2, in accordance with an exemplary embodiment of the present invention; and

FIGS. 4-14e illustrate exemplary graphical user interface windows displayable by the exemplary special-purpose Asymmetry-Based Scheduling System in accordance with an exemplary embodiment of the present invention.

### DETAILED DESCRIPTION

The present invention provides a computerized system and method for controlling a user interface to provide for asymmetrical, preferential scheduling of appointments on an incentivized basis. Accordingly, prioritization may be provided among patients requiring the same service, such that some patients should receive preferential treatment/prioritization from service providers in scheduling appointments. For example, one patient may have a “deluxe” health care insurance plan providing a relatively high level of service and appointment prioritization, while another may have a “standard” health care insurance plan providing a relatively lower level of service, resulting in a lower prioritization in terms of scheduling an appointment with a provider. A health plan might want to prioritize the service/appointment request of one such patient over another patient having a different health plan, even assuming the same clinical need. Alternatively, a health plan member may have a higher clinical need, for instance due to a recent hospitalization, but appointment scheduling is done by the providers without the plan being able to influence the timing or payments at a higher rate. Any conventional prioritization is not provided on a per-plan, per-patient-basis and rather is left to other, haphazard scheduling, for instance by a discharge nurse or a family member. Accordingly, such an approach treats groups of patients similarly, regardless of their individual medical needs or the priority of the patients' health plan(s), and favors premium-based/plan-based preferential treatment, without focusing on the different medical/healthcare needs of individual patients.

Accordingly, the system may be used, for example, by health plan operators to incentivize healthcare/medical providers to provide treatment to patients that are members of the health plan, to ensure treatment is rendered in better alignment with each individual patient's or plans' needs. Further, the system may be used by health plan operators to incentivize healthcare/medical providers to promote rendering of care in a manner providing better patient outcomes, or otherwise better meeting objectives of the health plan operator. Further still, the system may be used to provide financial or other reward to providers for better of faster care to patients. Other advantages including providing improved patient access to needed healthcare/medical resources, and the ability to align incentives with dynamic payment tools.

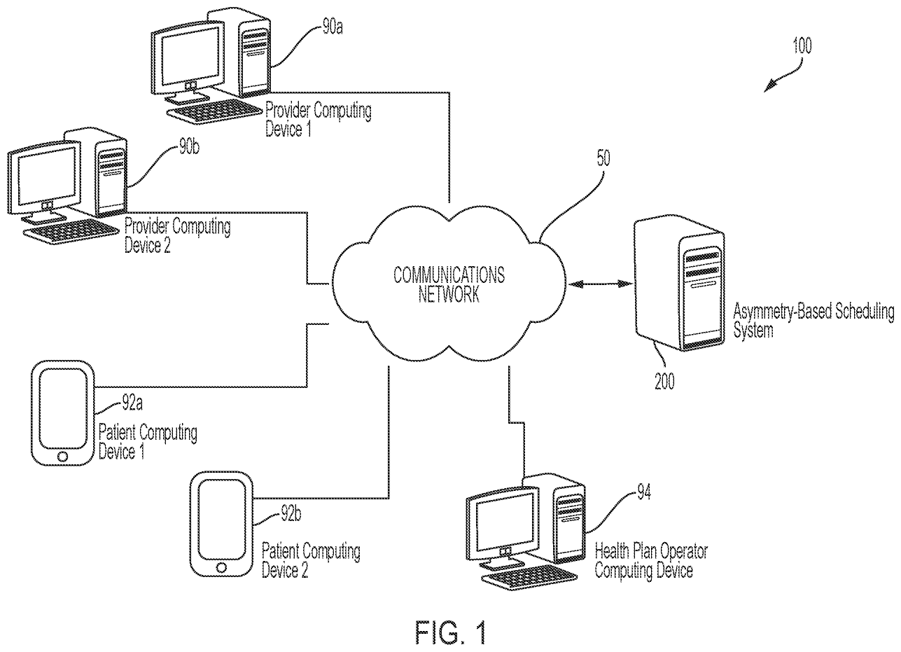

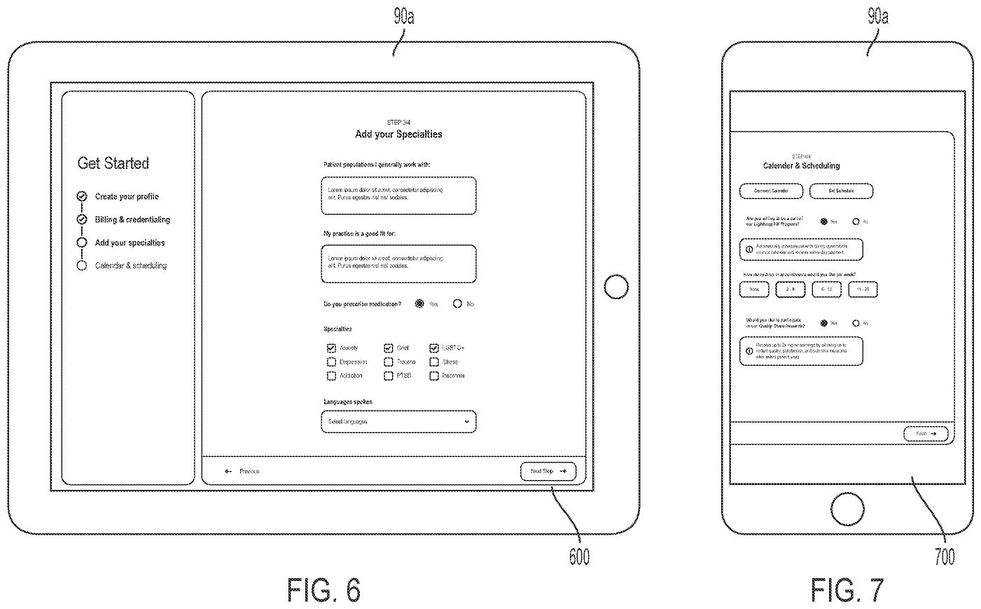

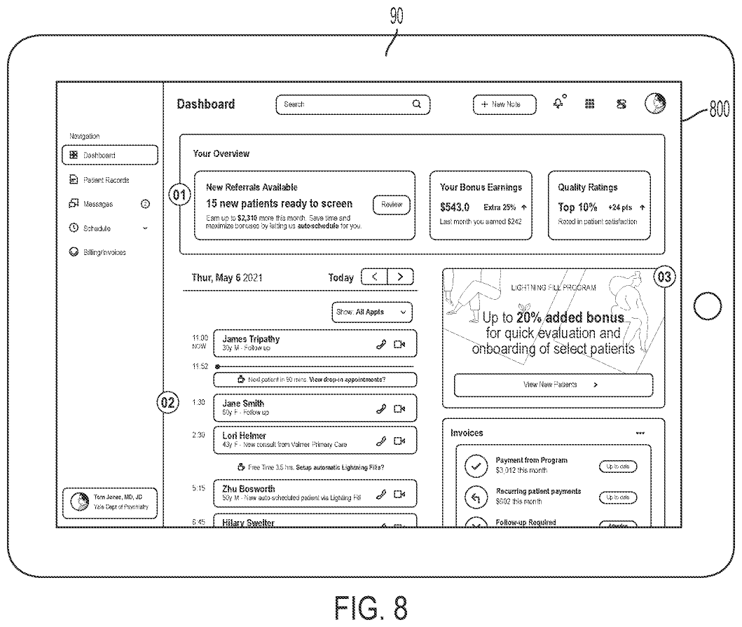

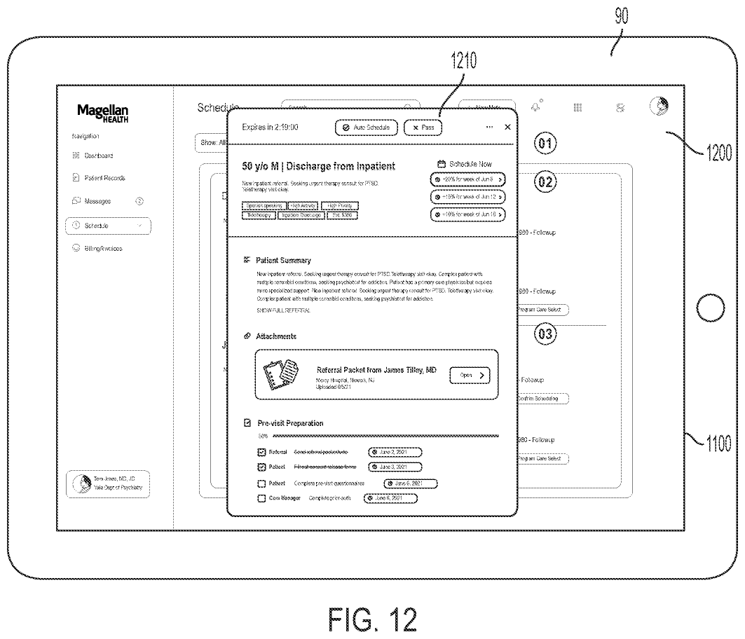

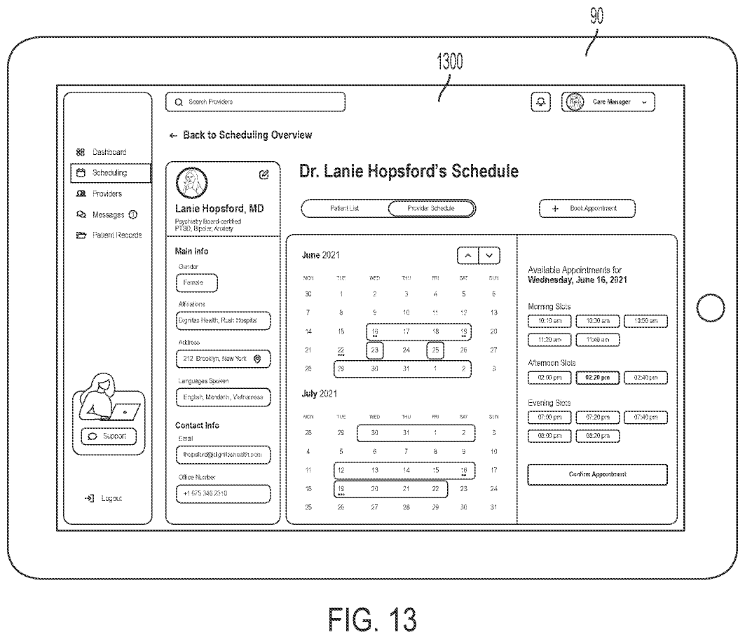

According to illustrative embodiment(s) of the present invention, various views are illustrated in FIGS. 1-14e and like reference numerals are used consistently throughout to refer to like and corresponding parts of the invention for all of the various views and figures of the drawings.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

### System Environment

An exemplary embodiment of the present invention is discussed below for illustrative purposes. FIG. 1 is a system diagram showing an exemplary network computing environment 100 in which the present invention may be employed. As shown in FIG. 1, the exemplary network environment 100 includes conventional computing hardware and software for communicating via a communications network 50, such as the Internet, etc., using Provider Computing Devices 90a, 90b, and/or Consumer Computing Devices 92a, 92b, and 92c, and/or Health Plan Operator Device 94, each of which may be, for example, one or more personal computers/PCs, laptop computers, tablet computers, smartphones, or other computing device hardware.

In accordance with a certain aspect of the present invention, one or more of the Provider Computing Devices 90a, 90b, and/or the Consumer Computing Devices 92a, 92b, 92c and/or Health Plan Operator Device 94 may store and execute an “app” or other purpose-specific application software in accordance with the present invention, although this is not required in all embodiments.

In accordance with the present invention, the network computing environment 100 further includes the Asymmetry-Based Scheduling System (ABSS) 200. In this exemplary embodiment, the ABSS 200 is operatively connected to the Provider Computing Devices 90a, 90b and the Consumer Computing Devices 92a, 92b, 92c and the Health Plan Operator Device 94 for data communication via the communications network 50. For example, the ABSS 200 may gather user data or other inputs from each device 90a, 90b, 92a, 92b, 92c, and 94 by data communication via the communications network 50. Hardware and software for enabling communication of data by such devices via such communications networks are well known in the art and beyond the scope of the present invention, and thus are not discussed in detail herein.

By way of example, the present invention may be used in the context of “three-way” scheduling (as opposed to traditional “two-way” approaches that only include two data points) for appointments for medical/healthcare services provided by medical/healthcare providers to patients/consumers. Accordingly, in the example of scheduling of appointments for medical/healthcare services, Provider Computer Devices 90a, 90b may be operated by medical/healthcare service providers, the Consumer Computing Devices 92a, 92b, 92c may be operated by patients or other consumers of medical/healthcare services, and the Health Plan Operator Device 94 may be operated by an operator of a health insurance plan.

After registration with ABSS 200, a Provider, Patient and/or Health Plan Operator may communicate with the ABSS 200 via the Provider, Consumer and/or Health Plan devices, and similarly, the ABSS 200 may communicate with the Providers, Patients Health Plan Operator via the Provider, Consumer and Health Plan Operator devices.

The Health Plan Operator (which can be a person or a computerized system operating programmatically) may use the Health Plan Operator Device 94 to define incentives to Providers for scheduling of appointments with one or more patients. In certain embodiments, the incentives may be defined for a class of patients, without reference to any particular patient, e.g., those having a particular condition, or having had a certain medical occurrence, etc. In other embodiments, incentives may be for a particular patient, on a per-patient basis. For example, the Health Plan Operator may define a financial incentive (e.g., an additional cash payment, an award of airline miles, a gift card, etc.) and/or a non-financial incentive, such as points towards recognition for seeing a particular patient for a particular purpose (e.g., for a behavioral health-type of appointment within the next 48 hours, to ensure that the patient's needs are met, or that a certain class of patients have follow-up or care or provider access according to the health plan's defined standards, preferences, etc.). By way of example, the Health Plan Operator may define these incentives by providing input to the ABSS 200 via a user interface provided at the Health Plan Operator Device 94 as a result of data transmitted from the ABSS 200 to the Health Plan Operator Device 94. Similarly, the ABSS 200 may transmit data to the Health Plan Operator Device 94 to cause display of alerts/messages describing the incentives, or alerting the Health Plan Operator to the existence/applicability of incentives.

In certain embodiments, a Provider may use the Provider Device to manage Provider resources, such as appointment capacity, by scheduling one or more patients for appointments with the Provider, to fill the provider's schedule as desired. In terms of assigning a particular appointment time to a particular patient, this may be performed and managed in a generally conventional fashion. By way of example, an appointment with a Provider may be requested by a patient by electronic communication, e.g., using the Consumer Computing Device, and a Provider may use the Provider Computing Device to assign an open appointment timeslot to a particular patient having made an appointment request. By way of example, the Provider may view incentives via the Provider Device 90a, 90b and schedule an appointment, perhaps as influenced by the available incentives, by providing input to the ABSS 200 via a user interface provided at the Provider Device 90a, 90b as a result of data transmitted from the ABSS 200 to the Provider Device 90a, 90b.

The scheduling information may be communicated from the Provider Device 90a, 90b to the Patient Computing Device 92a, 92b and/or to the ABSS 200, and may be managed by the ABSS 200 for the scheduling purposes described herein, namely, for permitting the Provider to interact with the ABSS 200 to schedule the appointment and to transmit data confirming the assigned appointment date/time, location, etc. to a Patient Computing Device and/or to effectively inform the ABSS 200 that the Provider is acting to earn the incentive. Alternatively, a message may go to all providers on the system to open new hours, such as evening or weekend hours, for a fee. Or the provider may have pre-set a threshold amount to automatically open certain hours automatically such that when the plan offers a cash or percentage-based bonus as an incentive to see a patient, the system may automatically add an open appointment and different potential times may have different thresholds. For instance, 5-6 PM might require a $20 or 20% increase in the fee but 6-7 PM may require $30 or 30%, in order for the system to automatedly add resource capacity (e.g., make an additional appointment available in those timeframes).

Accordingly, in accordance with the present invention, the definition of incentives and the communication of incentives to Providers, and the management of which patient to assign to an available appointment timeslot and/or which available appointment timeslot to assign to a requesting patient is performed in novel fashion, e.g., by way of the novel user interface of the ABSS 200 and/or the Provider Computing Device 90a, 90b, as described in greater detail below. More particularly, the Health Plan Operator may transmit data from the Health Plan Operator Device 94 to the ABSS 200 that will cause transmission of data from the ABSS 200 to the Provider Computing Devices 90a, 90b that cause display of financial and/or other incentives and/or associated notification messages to influence the Provider in scheduling an appointment with one or more patients to ensure that the individual patient receives appropriate care, or otherwise in accordance with the Health Plan Operator's objectives, as discussed in greater detail below.

### Asymmetry-Based Scheduling System

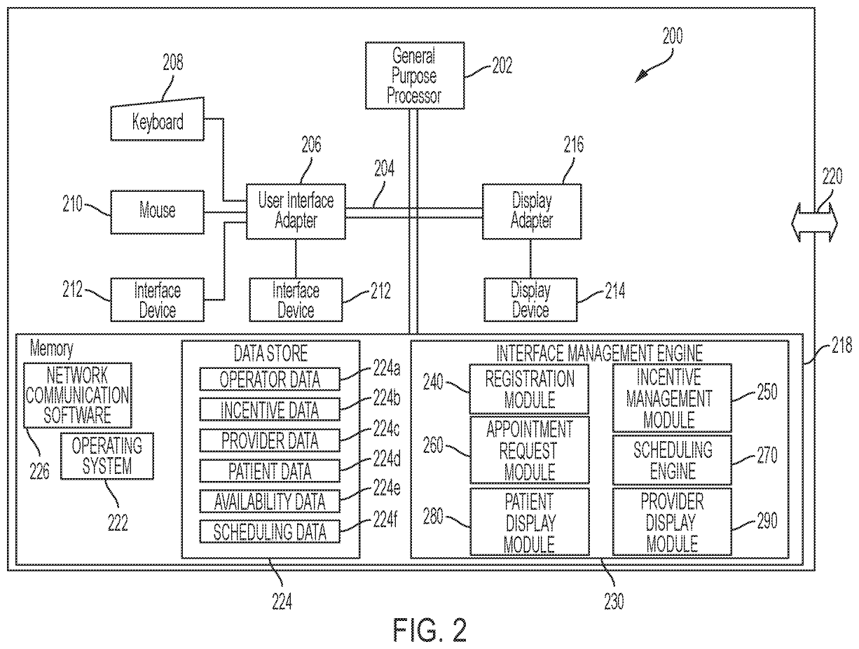

FIG. 2 is a block diagram showing an exemplary Asymmetry-Based Scheduling System (ABSS) 200 in accordance with an exemplary embodiment of the present invention. The ABSS 200 is a special-purpose computer system that includes conventional computing hardware storing and executing both conventional software enabling operation of a general-purpose computing system, such as operating system software 222, network communications software 226, and specially-configured computer software for configuring the general-purpose hardware as a special-purpose computer system for carrying out at least one method in accordance with the present invention. By way of example, the communications software 226 may include conventional web server software, and the operating system software 22 may include iOS, Android, Windows, Linux software.

Accordingly, the exemplary ABSS 200 of FIG. 2 includes a general-purpose processor, such as a microprocessor (CPU), 102 and a bus 204 employed to connect and enable communication between the processor 202 and the components of the presentation system in accordance with known techniques. The exemplary presentation system 200 includes a user interface adapter 206, which connects the processor 202 via the bus 204 to one or more interface devices, such as a keyboard 208, mouse 210, and/or other interface devices 212, which can be any user interface device, such as a camera, microphone, touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The ABSS 200 may communicate with other computers or networks of computers, for example via a communications channel, network card or modem 220. The ABSS 200 may be associated with such other computers in a local area network (LAN) or a wide area network (WAN), and may operate as a server in a client/server arrangement with another computer, etc. Such configurations, as well as the appropriate communications hardware and software, are known in the art.

The ABSS 200 is specially-configured in accordance with the present invention. Accordingly, as shown in FIG. 2, the ABSS 200 includes computer-readable, processor-executable instructions stored in the memory 218 for carrying out the methods described herein. Further, the memory 218 stores certain data, e.g., in one or more databases or other data stores 224 shown logically in FIG. 2 for illustrative purposes, without regard to any particular embodiment in one or more hardware or software components.

Further, as will be noted from FIG. 2, the ABSS 200 includes, in accordance with the present invention, a User Interface Management Engine (UIME) 230, shown schematically as stored in the memory 218, which includes a number of additional modules providing functionality in accordance with the present invention, as discussed in greater detail below. These modules may be implemented primarily by specially-configured software including microprocessor-executable instructions stored in the memory 218 of the ABSS 200. Optionally, other software may be stored in the memory 218 and and/or other data may be stored in the data store 224 or memory 218.

As shown in FIG. 2, the exemplary embodiment of the ABSS 200 also includes a Registration Module (RM) 240. The RM 240 is responsible for sending data to cause display of graphical user interface windows at a Health Plan Operator Computing Device 94 for gathering operator user account information, and for transmitting data via the network to cause display of graphical user interface windows at a Provider Computing Device 90a, 90b for gathering Provider user account information, and for transmitting data via the network to cause display of graphical user interface windows at a Consumer (e.g., patient) Computing Device 92a, 92b for gathering Consumer user account information, and for receiving/gathering such information and causing it to be stored in the data store 224 of the ABSS 200 as Operator Data, 224a, Provider Data 224c, Patient Data 224d, respectively.

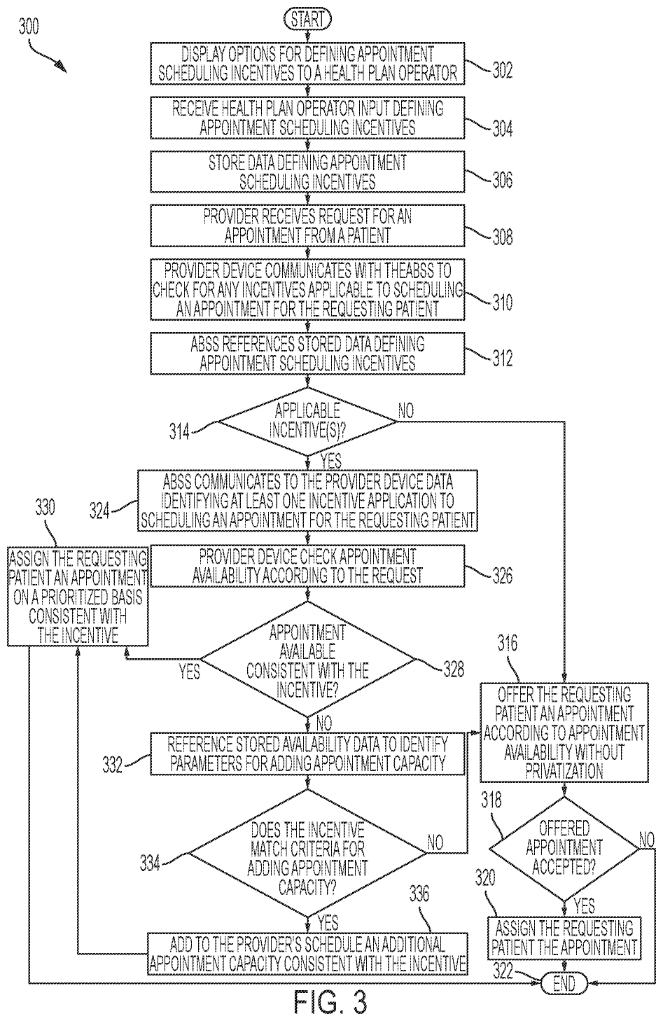

For example, the RM 240 may cause display of graphical user interface windows requiring a Provider to provide the following information as part of registration to create a user account for the provider: practice name, practice location/address, practice contact information, physicians, specialties, available procedures, insurances accepted, procedure pricing, availability for house calls. By way of example, this information may be gathered by the ABSS 200 by way of a graphical user interface window, such as windows 300, 400, 500 of FIGS. 3, 4 and 5, e.g., during creation of a physician/provider profile using the provider's smartphone, tablet, PC or other computing device to interact with the ABSS 200 via the network in an online data communications session. Accordingly, Providers can create an interactive and personalized profile to support patient matching activity and enable faster panel expansion.

Similarly, the RM 240 may cause display of graphical user interface windows requiring a Consumer to provide the information as part of registration to create a user account for the consumer/patient, such as: name, location/address, contact information, preferred physicians, preferred specialties, preferred procedures, insurance, house call preference, e.g., during creation of a patient/consumer profile using the patient/consumer's smartphone, tablet, PC or other computing device to interact with the ABSS 200 via the network in an online data communications session. Notably, this user account information includes not only basic identity and contact information but also, in accordance with the present invention, includes additional information that may be useful in performing the incentivized scheduling functionality described herein.

Similarly, the RM 240 may cause display of graphical user interface windows requiring an Operator/Health Plan Operator to provide information as part of registration to create a user account for the Operator, such as: diagnosis, ability to use telehealth options, member ID number, etc.

In accordance with the present invention, the exemplary embodiment of the ABSS 200 shown in FIG. 2 also includes an Incentive Management Module (IMM) 250. The IMM 250 is responsible for transmitting data via the network 50 to cause display of graphical user interface windows at a Health Plan Operator Computing Device 94 for gathering information about preferences, prioritization, weightings and incentives, etc. (collectively referred to herein as “incentives”) that are consistent with the Operator's objectives, e.g., to ensure treatment is rendered in better alignment with each individual patient's needs, to promote rendering of care in a manner providing better patient outcomes, or otherwise better meeting objectives of the health plan operator. The IMM 250 is further configured to receive/gather incentive information and cause it to be stored in the data store 224 of the ABSS 200 as Incentive Data 224b.

After Provider registration, the IMM 250 is operable to cause display alerts, prompts, textual and visual notices, etc. as part of a Provider dashboard user interface window caused to be displayed to the Provider via the Provider Computing Device by the ABSS 200 (e.g., by the UIME 230). This process may be managed at least in part by the IMM 250. More particularly, in accordance with the present invention, the exemplary embodiment of the ABSS 200 shown in FIG. 2 also includes a Provider Display Module (PDM) 290. The PDM 290 is responsible for transmitting data via the network 50 to cause display of graphical user interface windows at one or more Provider Computing Device 90a, 90b for displaying patient, appointments, messages, incentive alerts and other information to a Provider at a Provider Computing Device 90a, 90b, and also for gathering/receiving input from the Provider for scheduling appointments, taking advantage of incentive offers, etc.

In accordance with the present invention, the exemplary embodiment of the ABSS 200 shown in FIG. 2 also includes a Scheduling Engine (SE) 270. The SE 270 is responsible for matching a patient's/discharge planner's/care manager's request for an appointment with a particular day/timeslot for an appointment with a particular Provider. In particular, the SE 270 may reference the Provider's timeframes and/or other parameters/criteria specified by the Provider during registration (and stored as part of the Provider Data 224c) to understand when the Provider is likely to want to schedule an appointment (e.g., Wednesday mornings, generally). Further, the SE 270 may reference Availability Data 224e for the Provider, e.g., to determine if there is a particular Wednesday morning in the near future with an open Wednesday morning appointment timeslot for the Provider. If so, the Provider's user input, e.g., clicking the Auto-Schedule button, results in the SE 270 automatedly identifying the suitable open available timeslot for the Provider, assigning the suitable open available timeslot to the Patient, and storing associated data in the Scheduling Data 224f (e.g., to indicate that the particular timeslot has been allocated/assigned to a particular Patient, and to the Availability Data 224e (e.g., to reflect that the timeslot is no longer open). Alternatively, there may be provided an option such as “Any appointment in the next 7 days between 5 AM and 11 PM” and the system can query listed options but also offer incentives for new options outside normal clinic hours for a provider either due to an alert going to providers and asking them to agree to the incentive or auto-generated if a provider already allows for new hours to appear outside the normal hours if certain types of offers appear in the system.

The exemplary embodiment of the ABSS 200 shown in FIG. 2 also includes a Patient Display Module (PM) 280. The PM 280 is operable transmit data via the network 50 to cause display of graphical user interface windows at the Consumer Computing Device 92a, 92b.

System Operation

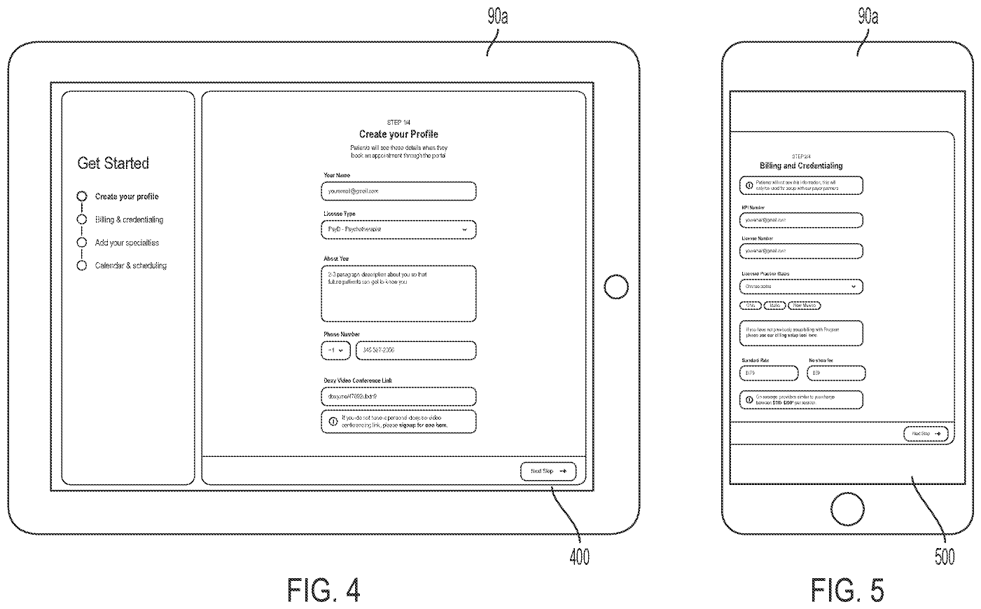

Exemplary operation of the system of FIGS. 1-2 is discussed below with reference to the flow diagram 300 of FIG. 3. The exemplary method involves registering at least one Provider with the ABSS 200. As discussed above, this may be performed at least in part by the RM 240 of the ABSS 200 causing display of graphical user interface windows at a Provider Computing Device 90a, 90b for gathering provider user account information. By way of example, this information may be gathered by the ABSS 200 by way of a graphical user interface window, such as windows 400, 500, 600 of FIGS. 4, 5 and 6, e.g., during creation of a physician/provider profile using the Provider's Computing Device 90a, 90b (e.g., smartphone, tablet, PC or other computing device), e.g., to interact with the ABSS 200 via the network 50 in an online data communications session.

FIG. 7 shows an exemplary graphical user interface window 700 displayable by the ABSS 200 at a Provider Computing Device 90a, 90b. The exemplary window 700 is configured to permit a Provider to provide input to opt-in/select incentive programs that have been defined by the Health Plan Operator 94 (as reflected by stored Incentive Data 224b), as discussed below. For example, Providers can provide input via the user interface window to set aside time blocks for the system to automatically fill with new patient visits or drop-in appointments. This may be performed at the provider level (for all patients), or on a per-patient or per-appointment request level. Providers may also provide input to enable better and faster reimbursement by signing up for automated quality and satisfaction tracking. Display of this information as part of the Provider's registration process may be managed at least in part by the RM 240.

Further, the exemplary method may involve registering at least one patient with the ABSS 200. As discussed above, this may be performed at least in part by the RM 240 of the ABSS 200 causing display of graphical user interface windows at a Patient Computing Device 92a, 92b for gathering patient user account information. By way of example, this information may be gathered by the ABSS 200 by way of a graphical user interface windows, such as windows e.g., during creation of a physician/provider profile using the provider's smartphone, tablet, PC or other computing device to interact with the ABSS 200 via the network in an online data communications session.

Referring now to FIG. 3, it will be appreciated that an exemplary method of operation of a system in accordance with the present invention involves the display at a Health Plan Operator Computing Device 94 (to a Health Plan Operator) of options for defining appointment scheduling incentives, as shown at 302. This may involve registering at least one Health Plan Operator with the ABSS 200. As discussed above, this may be performed at least in part by the RM 240 of the ABSS 200 causing display of graphical user interface windows at a Health Plan Operator Computing Device 94 for gathering health plan operator account information. As discussed above, this may be performed at least in part by the IMM 250 of the ABSS 200 causing display of graphical user interface windows at a Health Plan Operator Computing Device 94 for gathering information about preferences, prioritization, weightings and incentives, etc. (collectively referred to herein as “incentives”) that are consistent with the Operator's objectives, e.g., to ensure treatment is rendered in better alignment with each individual patient's needs, to promote rendering of care in a manner providing better patient outcomes, or otherwise better meeting objectives of the health plan operator. Further still, incentive information may be gathered about financial or other rewards to that the Operator is willing to provide to Providers for work to help achieve those objectives. These incentives help to influence Provider behavior in scheduling appointments, and thus provides an asymmetry, in terms of allocating available appointment resources to patients/consumers, including those requiring the same service, that is consistent with the Health Plan Operator's objectives. These incentives may change over time, and the incentive data may be updated over time to reflect such changes.

The exemplary method next involves receiving Health Plan Operator input defining appointment scheduling incentives, as shown at 304. As discussed above, the incentive information may be stored in the data store 224 of the ABSS 200 as Incentive Data 224b, as shown at 306. This may be performed by the RM 240 and/or the IMM 250, and may involve communication among one or more of the Health Plan Operator Computing Device 94 and/or the ABSS 200.

Next, the exemplary method involves a Health Care Provider receiving a request for an appointment from a Patient, as shown at 308. By way of example, this may occur by a Patient inputting information into a suitable graphical user interface window caused to be displayed at the Patient Computing Device 92a, 92b by the Appointment Request Module 260 of the ABSS 200, or may occur by a Provider inputting information into a suitable graphical user interface window caused to be displayed at the Provider Computing Device 90a, 90b by the ARM 260 or the ABSS 200, e.g., when a patient places a telephone call to a Provider to request an appointment, or communicates with a Provider/Provider Computing Device 90a, 90b via a chat/text-based interface, which may be caused to be displayed by the Provider Display Module 290 of the ABSS 200.

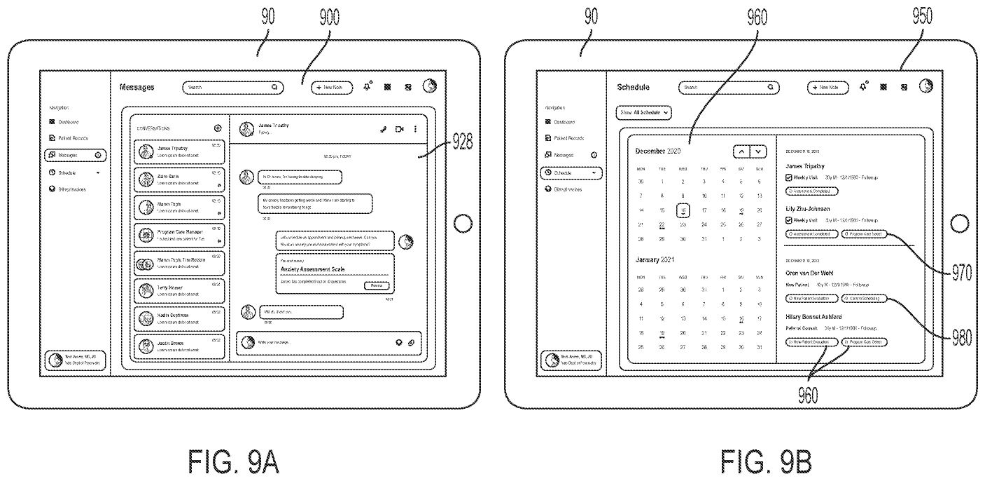

FIGS. 9A and 9B show exemplary graphical user interface windows 900, 950 displayable by the ABSS 200/PDM 290 at a Provider Computing Device 90a, 90b. In part, the PDM 920 may cause display of a graphical user interface window 900 providing a chat/text-based interface 920 for communicating with a patient, and for scheduling an appointment. As will be appreciated from FIG. 9A, the graphical user interface window 900 caused to be displayed by the PDM 290 may provide an interface 920 for multi-channel care options (e.g., via video, phone and text messaging) for deeper patient engagement between visits.

In part, the PDM 290 may cause display of a graphical user interface window 950 showing graphically or otherwise appointment Availability Data 224e and Scheduled Appointment Data 224f, as well as causing updating of such data as changes by scheduling or canceling an appointment occurs. The graphical user interface window's alerts may be in the form of dynamic pop-ups, banners or other alerts displayed via the graphical user interface window, and the window may display a tall of cumulative incentives to date for a given period. As will be appreciated from FIG. 9B, the graphical user interface window 950 caused to be displayed by the PDM 290 may provide a calendar display 960 of appointments and/or proposed appointments with visually observable tags (e.g., Program Care Select) 970 that identify high-priority (high incentive) patients and new appointments, etc. The PDM 290 may also cause graphical user interface windows to be displayed to the Provider to schedule an appointment and/or to permit automatic scheduling of a patient by the system (e.g., ABSS 200), e.g., via selection of user-selectable “Schedule” button 980.

In this exemplary embodiment, the Provider Computing Device and/or ABSS 200 then checks for any incentives applicable to scheduling an appointment for the particular patient making a request, as shown at 310. For example, this may involve checking Provider Data 224c, Patient Data 224d, Operator Data 224a, Incentive Data 224b and/or Availability Data 224e.

In this exemplary embodiment, the ABSS 200 then references the stored data defining the appointment scheduling incentives, as shown at 312. By way of example, this may be performed by Scheduling Engine 270.

Referring again to the exemplary embodiment of FIG. 3, the exemplary embodiment next involves determining whether there are applicable incentives for scheduling of an appointment satisfying the request, as shown at 314. If not, then a provider/the Provider Computing Device 90a, 90b/the ABSS 200 may simply offer the requesting patient/Patient Computing Device 92a, 92b an appointment (e.g., at a particular location, day, time, etc., with a particular provider, etc.) according to appointment availability without any incentive-based prioritization, as shown at 316. For example, this may be performed in a generally conventional manner, e.g., on a next-available basis. In accordance with the present invention, this may involve display of suitable text, images, notifications, etc. via a Patient Computing Device 92, 92b. This may be performed by the Scheduling Engine 270, Patient Display Module 280 and/or Provider Display Module 290, and may involve communication among one or more of the Provider Computing Device 90a, 90b, Patient Computing Device 92a, 92b, and/or the ABSS 200.

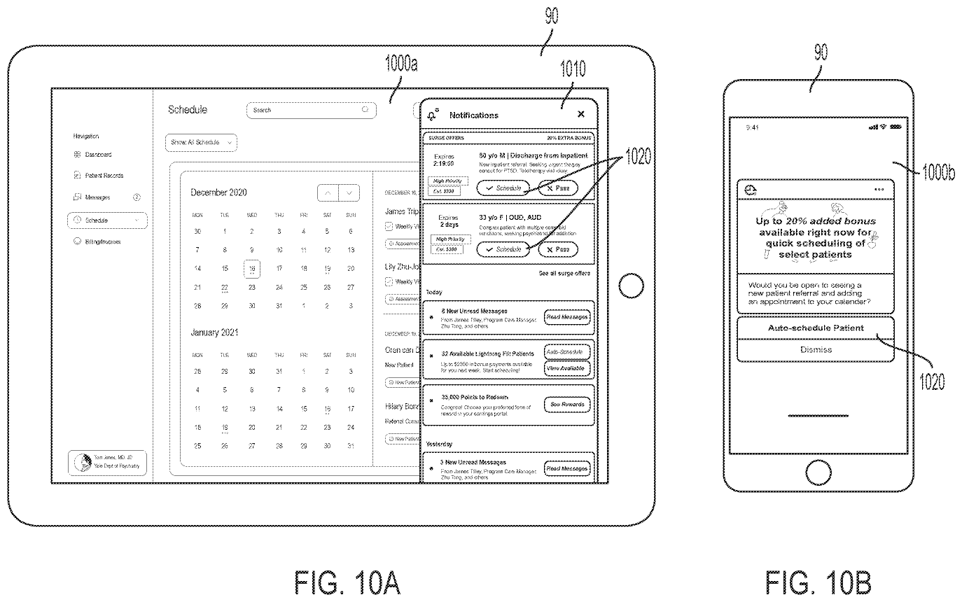

As will be appreciated from FIGS. 10A and 10B, the graphical user interface window 1000a, 1000b caused to be displayed by the PDM 290 may cause display of a graphical user interface window 1000a featuring a display of incentive alerts 1010 that provide user-selected graphical user elements (e.g., Schedule button 1020 of FIGS. 10A and 10B) operable to enable the Provider to opt-in to incentives within their scheduled workflow (Availability Data 224e) to maximize Provider efficacy and earnings, e.g., by Scheduling an Appointment with an incentive displayed in the incentive alerts 1010. Further still, the graphical user interface window's alerts may be displayed to implement campaigns enabling faster new patient on-boarding and higher provider network engagement.

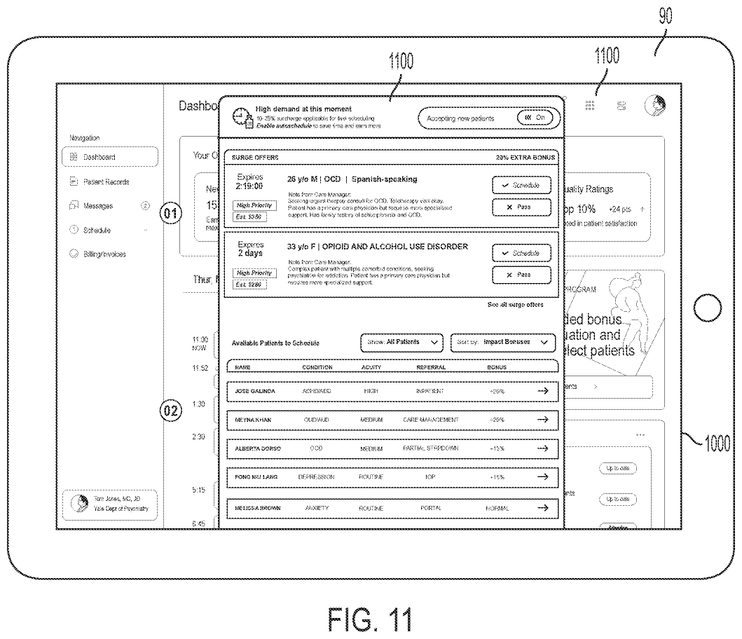

The ABSS 200/PDM 290 may also display a graphical user interface window having a panel 1110 identifying surge offers/incentives for high-priority patients, and dynamic sorting of patients who have requested appointments, as will be appreciated from graphical user interface windows 1100, 1200 and 1300, shown in FIGS. 11-13. This user interface dashboard for the provider can be customized according to the types of incentives that this individual Provider prefers. For example, a Provider may prefer more rapid payment, or sharing data for incentives rather than higher payments scheduling appointments in for expanded hours (e.g., outside normal business hours). This may involve retrieval of data from the Patient Data 224d, which may include not only patient-identifying information but also Appointment Request data, which may be managed by the Appointment Request Module (ARM) 260 of the ABSS 200.

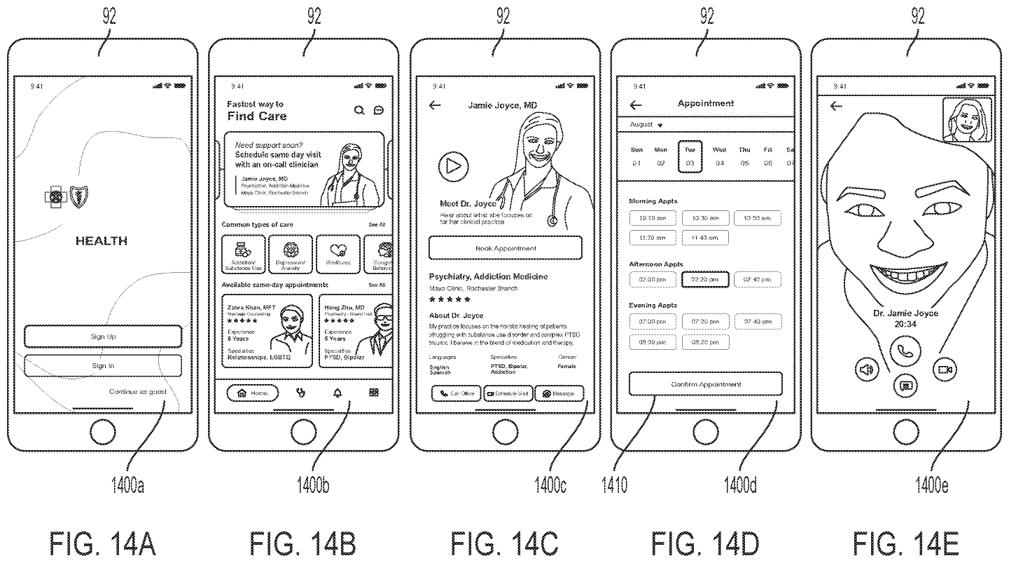

It is then determined if the offered appointment is accepted, as shown at 318. If not, the method may end, as shown at 322. If so, then the offered appointment may be assigned to the requested patient, as shown at 320, and the method may end, as shown at 322. This assignment of the appointment may be performed by the Scheduling Engine 270, Patient Display Module 280 and/or Provider Display Module 290, and may involve communication among one or more of the Provider Computing Device 90a, 90b, Patient Computing Device 92a, 92b, and/or the ABSS 200. In accordance with the present invention, the ARM 260 and/or Patient Display Module 280 are responsible for managing requests that a patient be scheduled for an appointment with a healthcare provider, and thus for transmitting data via the network 50 to cause display of graphical user interface windows at one or more Patient Computing Device 92a, 92b for gathering information about appointments desired/requested. These requests may originate from the patients/Patient Computing Devices 92a, 92b, as will be appreciated from the graphical user interface windows 1400a, 1400b, 1400c, 1400d, 1400e of FIGS. 14a-14e. These graphical user interface windows display alerts, Provider Information (e.g., retrieved from the Provider Data 224c), Appointment Availability (days/times) (e.g., retrieved from the Availability Data 224e) and optionally a user-selectable button 1310 to confirm/accept a proposed appointment date/time proposed by the Provider and/or by the ABSS 200 on the Provider's behalf, as part of Patient portal user interface windows 1400a, 1400b, 1400c, 1400d, 1400e, caused to be displayed to the Patient by the ABSS 200 (e.g., by the UIME 230), which process may be managed at least in part by the IMM 250, SE 270 and/or PDM 290. The user interface windows may provide video chat functionality, as shown in window 1400e, of other communication functionality, e.g., to hold an “virtual”/online meeting with a Provider at the designated appointment time.

If, however, it is determined at 314 that there are applicable incentives for scheduling of an appointment satisfying the request, then the ABSS 200 (in this embodiment) communicates to the Provider Computing Device 92a, 92b data identifying at least one incentive applicable to scheduling an appointment for the requesting patient, as shown at 324. For example, this may involve the ABSS 200 causing cause display of alerts, prompts, textual and/or visual notices, etc. as part of a Provider dashboard user interface window caused to be displayed to the Provider via the Provider Computing Device 92a, 92b by the ABSS 200 (e.g., by the UIME 230). This process may be performed at least in part by the IMM 250 and/or the PDM 290.

In this embodiment, the Provider Computing Device 92a, 92b then checks for appointment availability according to the patient's request, as shown at 326. For example, this may involve the Provider Computing Device 92a, 92b checking Availability Data 224e at the Provider Computing Device 92a, 92b and/or the ABSS 200. This may be performed by the Appointment Request Module 260, Patient Display Module 280 and/or Provider Display Module 290, and may involve communication among one or more of the Provider Computing Device 90a, 90b, Patient Computing Device 92a, 92b, and/or the ABSS 200.

Next, it is determined whether an appointment is available that is consistent with the incentive(s) available, as shown at 328. For example, this may involve identifying applicable Incentive Data 224b (e.g., applicable to a certain patient, health plan, health plan operator, healthcare provider, service, etc.) and comparing it to Availability Data 224e. For example, it may be identified that the patient request is of an appointment for a particular service, or with a particular provider, e.g., within a 2-week timeframe, and it may be identified that there is an incentive for the patient to be seen within 3 days, and it is determined whether there is a suitable appointment available within the next 3 days, consistent with the incentive. For example, this may involve the Provider Computing Device 92a, 92b checking Incentive Data 224b and Availability Data 224e at the Provider Computing Device 92a, 92b and/or the ABSS 200. This may be performed by the IMM 250, ARM 260, Scheduling Engine 270, Patient Display Module 280 and/or Provider Display Module 290, and may involve communication among one or more of the Provider Computing Device 90a, 90b, Patient Computing Device 92a, 92b, and/or the ABSS 200.

It is determined at 328 that there is an appointment available that is consistent with the incentive, then the system assigns the requesting patient an appointment on a prioritized basis consistent with the incentive, as shown at 330. For example, this may involve scheduling the patient for an appointment within the next 3 days, as discussed above, and the method may end, as shown at 322. This assignment of the appointment may be performed by the Scheduling Engine 270, Patient Display Module 280 and/or Provider Display Module 290, and may involve communication among one or more of the Provider Computing Device 90a, 90b, Patient Computing Device 92a, 92b, and/or the ABSS 200.

If, however, it is determined at 328 that there is no appointment available that is consistent with the incentive, then the system references stored Availability Data 224e to identify parameters for adding appointment capacity, as shown at 332. For example, the Availability Data 224e may indicate that a certain provider will make appointments available between the hours of 9 am and 4 pm on a regular basis, but will also see patients between the hours of 4 pm and 6 pm for a certain incentive (e.g., a minimum premium payment or other incentive having a value of at least $20) and will also make appointments available between the hours of 6 pm and 8 pm for a different incentive (e.g., a minimum premium payment or other incentive having a value of at least $50). For example, this may involve the Provider Computing Device 92a, 92b checking Availability Data 224e at the Provider Computing Device 92a, 92b and/or the ABSS 200. This may be performed by the Appointment Request Module 260, Patient Display Module 280 and/or Provider Display Module 290, and may involve communication among one or more of the Provider Computing Device 90a, 90b, Patient Computing Device 92a, 92b, and/or the ABSS 200.

Next, it is determined whether an available incentive matches/is compatible with/meets the parameters for adding appointment capacity, as shown at 334. For example, this may involve identifying applicable Incentive Data 224b and comparing it to parameters for adding appointment capacity of the Availability Data 224e. For example, it may be identified that there is an incentive to see the patient within the next 3 days that has a value of $30, and that that meets/matches with the parameter for adding additional appointment capacity between 4 pm and 6 pm of a minimum premium payment or other incentive having a value of at least $20. For example, this may involve the Provider Computing Device 92a, 92b checking Incentive Data 224b and Availability Data 224e at the Provider Computing Device 92a, 92b and/or the ABSS 200. This may be performed by the IMM 250, ARM 260, Scheduling Engine 270, Patient Display Module 280 and/or Provider Display Module 290, and may involve communication among one or more of the Provider Computing Device 90a, 90b, Patient Computing Device 92a, 92b, and/or the ABSS 200.

If it is determined at 334 that there is an available incentive that matches/is compatible with/meets the parameters for adding appointment capacity, then the system adds to the provider's schedule additional appointment capacity, e.g., an additional 4 pm appointment, consistent with the incentive, as shown at 336. This may be performed by the Scheduling Engine 270, Patient Display Module 280 and/or Provider Display Module 290, and may involve communication among one or more of the Provider Computing Device 90a, 90b, Patient Computing Device 92a, 92b, and/or the ABSS 200. The system then assigns the requesting patient the suitable appointment on a prioritized basis consistent with the incentive, as shown at 330, and the method ends, as shown at 322.

If, however, it is determined at 334 that there is no available incentive that matches/is compatible with/meets the parameters for adding appointment capacity, then the system offers the requesting patient/Patient Computing Device 92a, 92b an appointment (e.g., at a particular location, day, time, etc., with a particular provider, etc.) according to appointment availability without any incentive-based prioritization, as shown at 316, it is determined whether the offered appoint is accepted at 318, and the appointment is assigned to the patient if accepted as shown at 320, and/or the method ends, as shown at 322.

Accordingly, it will be appreciated that the present invention provides a computerized system and method for providing asymmetry-based scheduling of appointments, such that appointment requests are not handled only on a first-come first-served basis, but rather are handled on a prioritized basis, as that prioritization is reflected in incentives defined by the operator/health plan operator to promote scheduling of appointments in a manner consistent with the operator's objectives, e.g., to ensure better care to a group of patients in a need-based, prioritized manner. Further, Providers are provided with graphical user interfaces and system tools for scheduling appointments according to/starting with incentives offered, rather than simply in a manner that is responsive to an order of requests for appointments. Thus, the present invention provides a system that improves the efficiency of use of limited appointment resources, and has the ability to incentive and reward behavior desired by the operator, e.g., so that tasks valued more highly by the operator can be rewarded at a higher level of compensation.

The various implementations and examples shown above illustrate a method and system for performing asymmetric/prioritized resource allocation (e.g., appointment scheduling) using an electronic device. As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense. By way of example, one or more system components or functions described with respect to any of the Provider Computing Device, Patient Computing Device, Health Plan Operator Device and the Asymmetry-Based Scheduling System may instead be incorporated in and/or provided by another one or more of such other devices and/or systems.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an exemplary embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a smart phone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard or touchscreen), a cursor control device (e.g., a mouse or gestures on a touchscreen), a drive unit, a signal generation device (e.g., a speaker and microphone) and a network interface device.

The system may include a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The present invention may be operational with numerous other general-purpose or special-purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, cellular telephones, network PCs, minicomputers, mainframe computers, distributed computing environments that include any of the above-mentioned systems or devices, and the like.

The present invention has been described in the general context of computer-executable instructions, such as program modules or engines, being executed by a computer. Generally, program modules/engines include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules/engines may be located in local and/or remote computer-storage media including, by way of example only, memory storage devices.

The exemplary computing system may include general-purpose computing hardware in the form of a server. Components of the server may include, without limitation, a processing unit, internal system memory, and a suitable system bus for coupling various system components, including a database cluster, with the server. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The server typically includes therein, or has access to, a variety of computer-readable media, for instance, via a database cluster. Computer-readable media can be any available media that may be accessed by the server, and includes volatile and nonvolatile media, as well as removable and non-removable media. By way of example, and not limitation, computer-readable media may include computer-storage media and communication media. Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information, and which may be accessed by the server. Communication media typically embodies computer readable instructions, data structures, program modules, or other data in a modulated data signal, such as a carrier wave or other transport mechanism, and may include any information delivery media. The term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The ABSS 200 may function as a server. The server may operate in a computer network using logical connections to one or more remote computers. Remote computers may be located at a variety of locations or over the Internet. The remote computers may be personal computers, servers, routers, network PCs, peer devices, other common network nodes, or the like, and may include some or all of the elements described above in relation to the server. The computing devices can be personal digital assistants or other like devices.

Exemplary computer networks may include, without limitation, local area networks (LANs) and/or wide area networks (WANs). Such networking environments are commonplace in offices, enterprise-wide computer networks, intranets, and the Internet. When utilized in a WAN networking environment, the server may include a modem/network card or other means for establishing communications over the WAN, such as the Internet. In a networked environment, program modules or portions thereof may be stored in the server, in the database cluster, or on any of the remote computers. For example, and not by way of limitation, various application programs may reside on the memory associated with any one or more of the remote computers. It will be appreciated by those of ordinary skill in the art that the network connections shown are exemplary and other means of establishing a communications link between the computers (e.g., the server and remote computers) may be utilized.

In operation, a user may enter commands and information into the server or convey the commands and information to the server via one or more of the remote computers through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote device to the server. In addition to a monitor, the server and/or remote computers may include other peripheral output devices, such as speakers and a printer.

Many other internal components of the server and the remote computers/computing devices are not shown because such components and their interconnection are well known. Accordingly, additional details concerning the internal construction of the server and the remote computers/computing devices are not further disclosed herein.

Although methods and systems of embodiments of the present invention may be implemented in a WINDOWS or LINUX operating system, operating in conjunction with an Internet-based delivery system, one of ordinary skill in the art will recognize that the described methods and systems can be implemented in any system supporting the functionality described herein. As contemplated by the language above, the methods and systems of embodiments of the present invention may also be implemented on a stand-alone desktop, personal computer, cellular phone, smart phone, tablet, PDA, or any other computing device used in various locations.

Additionally, computer readable media storing computer readable code for carrying out the method steps identified above is provided. The computer readable media stores code for carrying out subprocesses for carrying out the methods described herein.

A computer program product recorded on a computer readable medium for carrying out the method steps identified herein is provided. The computer program product comprises computer readable means for carrying out the methods described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An asymmetry-based scheduling system comprising:
a memory operatively comprising a non-transitory data processor-readable medium;
a data processor operatively connected to the memory;
user interface management instructions embodied in data processor-executable code stored in the memory, said user interface management instructions being executable by the data processor to provide a user interface management engine configured to:
identify a requestor's request for an appointment with a provider;
reference stored incentive data applicable to the requestor's request, the incentive data defining criteria for earning an incentive for scheduling the appointment the requestor;
reference stored appointment availability data and determine whether the provider has an available appointment compatible with the criteria for earning the incentive;
if the provider has an available appointment compatible with the criteria for earning the incentive, then assign the available appointment to the requestor on a prioritized basis compatible with the criteria;
display, on a display device of a computing system, an indication that the available appointment has been assigned to the requestor.

2. The system of claim 1, wherein said user interface management instructions further comprises instructions executable by the data processor to configure the user interface management engine to:
if the provider does not have an available appointment compatible with the criteria for earning the incentive, then:
reference stored appointment availability data applicable to the requestor's request, the appointment availability data defining parameters for adding additional appointment capacity;
determine whether the incentive data applicable to the requestor's request is compatible with the parameters for adding additional appointment capacity; and
if the incentive data applicable to the requestor's request is compatible with the parameters for adding additional appointment capacity, then:
add an additional available appointment compatible with the criteria for earning the incentive;
assign the additional available appointment to the requestor on a prioritized basis compatible with the criteria; and
display, on the display device of the computing system, the indication that the additional available appointment has been assigned to the requestor.

3. The system of claim 1, wherein said user interface management instructions further comprises instructions executable by the data processor to configure the user interface management engine to:
display, on at least one display device, at least one option selectable to define an appointment scheduling incentive and criteria for earning the incentive; and
receive input defining at least one appointment scheduling incentive and associated criteria for earning the at least one appointment incentive.

4. The system of claim 3, wherein said user interface management instructions further comprises instructions executable by the data processor to configure the user interface management engine to:
display, on at least one display device, at least one option selectable to define an appointment scheduling incentive having a monetary value.

5. The system of claim 1, wherein said user interface management instructions executable to configure the user interface management engine to identify a requestor's request for an appointment with a provider comprise instructions to receive appointment request data transmitted via a communications network.

6. An asymmetry-based scheduling system comprising:
a memory operatively comprising a non-transitory data processor-readable medium;
a data processor operatively connected to the memory;
user interface management instructions embodied in data processor-executable code stored in the memory, said user interface management instructions being executable by the data processor to provide a user interface management engine configured to:
reference stored incentive data applicable to scheduling of appointments with patients, the incentive data defining criteria for earning an incentive for scheduling an appointments;
reference stored appointment availability data and determine whether the provider has an available appointment, for a patient, that is compatible with the criteria for earning the incentive; and
if the provider has an available appointment, for the patient, that is compatible with the criteria for earning the incentive, then:
assign the available appointment to the patient on a prioritized basis compatible with the criteria; and
display, on a display device of a computing system, an indication that the available appointment has been assigned to the patient.

7. The system of claim 6, wherein said user interface management instructions further comprises instructions executable by the data processor to configure the user interface management engine to:
if the provider does not have an available appointment, for the patient, that is compatible with the criteria for earning the incentive, then:
reference stored appointment availability data applicable to an appointment for the patient, the appointment availability data defining parameters for adding additional appointment capacity;
determine whether the incentive data applicable to the appointment for the patient is compatible with the parameters for adding additional appointment capacity; and
if the incentive data applicable to the appointment, for the patient, is compatible with the parameters for adding additional appointment capacity, then:
add an additional available appointment compatible with the criteria for earning the incentive;
assign the additional available appointment to the patient on a prioritized basis compatible with the criteria; and
display, on the display device of the computing system, the indication that the additional available appointment has been assigned to the patient.

8. The system of claim 6, wherein said user interface management instructions further comprises instructions executable by the data processor to configure the user interface management engine to:
display, on at least one display device, at least one option selectable to define an appointment scheduling incentive and criteria for earning the incentive; and
receive input defining at least one appointment scheduling incentive and associated criteria for earning the at least one appointment incentive.

9. The system of claim 8, wherein said user interface management instructions further comprises instructions executable by the data processor to configure the user interface management engine to:
display, on at least one display device, at least one option selectable to define an appointment scheduling incentive having a monetary value.

10. The system of claim 6, wherein said user interface management instructions comprise instructions executable to configure the user interface management engine to identify a requestor's request for an appointment with a provider.

11. The system of claim 6, wherein said user interface management instructions comprise instructions executable to display, on a computing device, a graphical user interface window displaying at least one appointment that is available to be scheduled for a particular patient in conjunction with an identification of the incentive for scheduling the appointment for the particular patient.

12. The system of claim 6, wherein said user interface management instructions comprise instructions executable to display, on a computing device, a graphical user interface window displaying at least one patient that is ready to be assigned an appointment in conjunction with an identification of the incentive for scheduling the appointment for the particular patient.

13. The system of claim 6, wherein said user interface management instructions comprise instructions executable to display, on a computing device, a graphical user interface window displaying an incentive for at least one appointment and a user-selectable button selectable to cause automated assignment of at least one appointment to at least one patient on a prioritized basis compatible with applicable criteria for earning an incentive applicable to each appointment.

14. The system of claim 6, wherein said user interface management instructions comprise instructions executable to display, on a computing device, a graphical user interface window displaying a first request for a first appointment for a first patient without an applicable incentive and a second request for a second appointment for a second patient with an applicable incentive, in conjunction with an identification of the applicable incentive for scheduling the second appointment for the second patient, along with a user-selectable button selectable to initiate assignment of an appointment to the second patient on a prioritized basis compatible with applicable criteria for earning an incentive.

15. The system of claim 6, wherein said user interface management instructions comprise instructions executable to display, on a computing device, a graphical user interface window displaying a list comprising a plurality of requests for appointments for a plurality of patients, each of said plurality of requests being displayed in conjunction with a respective applicable for scheduling an appoint on a prioritized basis compatible with applicable criteria for earning the incentive.

16. The system of claim 15, wherein said user interface management instructions comprise instructions executable to display, on a computing device, a graphical user interface window displaying the list, wherein the plurality of requests for appointments are sorted in order of applicable incentives, prioritized in accordance with a preference.

17. The system of claim 16, wherein said user interface management instructions comprise instructions executable to display, on a computing device, a graphical user interface window displaying the list, sorted in order of applicable incentives, prioritized in accordance with the preference, wherein the preference is one of a highest monetary value, a shortest time to payment, and a certain data sharing permission.

18. A computer-implemented method of controlling a display of a computerized device to provide asymmetry-based scheduling, the computerized device comprising a memory operatively comprising a non-transitory data processor-readable medium, a data processor operative connected to the memory, the display and the user input component, and user interface management instructions embodied in data processor-executable code stored in the memory and executable by the data processor, the method comprising:
referencing stored incentive data applicable to scheduling of appointments with patients, the incentive data defining criteria for earning an incentive for scheduling an appointments;
referencing stored appointment availability data and determine whether the provider has an available appointment, for a patient, that is compatible with the criteria for earning the incentive; and
if the provider has an available appointment, for the patient, that is compatible with the criteria for earning the incentive, then:
assigning the available appointment to the patient on a prioritized basis compatible with the criteria; and
displaying, on a display device of a computing system, an indication that the available appointment has been assigned to the patient.

19. The method of claim 18, wherein the method further comprises:
displaying, on a computing device, a graphical user interface window displaying at least one appointment that is available to be scheduled for a particular patient in conjunction with an identification of the incentive for scheduling the appointment for the particular patient.

20. A computer program product for implementing a method of controlling a display of a computerized device to provide asymmetry-based scheduling, the computer program product comprising a non-transitory computer-readable medium storing executable instructions that, when executed by a processor, cause a computerized asymmetry-based scheduling system to perform a method comprising:
referencing stored incentive data applicable to scheduling of appointments with patients, the incentive data defining criteria for earning an incentive for scheduling an appointments;
referencing stored appointment availability data and determine whether the provider has an available appointment, for a patient, that is compatible with the criteria for earning the incentive; and
if the provider has an available appointment, for the patient, that is compatible with the criteria for earning the incentive, then:
assigning the available appointment to the patient on a prioritized basis compatible with the criteria; and
displaying, on a display device of a computing system, an indication that the available appointment has been assigned to the patient.

21. The computer program product of claim 20, further comprising executable instructions that, when executed by a processor, cause the computerized asymmetry-based scheduling system to perform the method, the method further comprising:
displaying, on a computing device, a graphical user interface window displaying at least one appointment that is available to be scheduled for a particular patient in conjunction with an identification of the incentive for scheduling the appointment for the particular patient.
